(19) United States
(12) Patent Application Publication
(10) Pub. No.: US 2008/0296294 A1
(43) Pub. Date: Dec. 4, 2008

(54) Pure steam torch by microwaves for reforming of hydrocarbon fuels

(76) Inventor: Han Sup Uhm, Potomac, MD (US)

Correspondence Address: Han Sup Uhm, 11613 Swains Lock Terrace, Potomac, MD, 20854, US

(21) Appl. No.: 11/806,103

(22) Filed: May 30, 2007

(51) Int. Cl. H05B 6/80

(52) U.S. Cl. 219/688

(57) ABSTRACT

The present invention relates to an apparatus and method for generating pure steam torch by microwaves and more particularly to the microwave steam torch for reforming hydrocarbon fuels by injecting steam into discharge tube energized by microwaves and by injecting the fuels into high temperature steam-plasma. The invention provides a compact and portable apparatus for generating pure steam torch. The apparatus includes a magnetron, an electrical power supplier, a waveguide system, a microwave power monitoring system, stub tuners, a discharge tube, a steam supply system, a plasma ignitor and fuel injection system for reforming of hydrocarbon fuels. The method is also described for reforming of hydrocarbon fuels by injecting gaseous, liquid or solid-powder hydrocarbon-fuels into the microwave steam torch to decompose the hydrogen and carbon containing fuels, and to mix the resultant gaseous carbon compounds with oxygen or hydroxide molecules, instantaneously generating hydrogen or other hydrocarbon compounds.

### REFERENCE CITED: U.S. PATENT DOCUMENTS

| | | |
|---|---|---|
| 6,620,394 B2 | September 2003 | Uhm et al |
| 6,806,439 B2 | October 2004 | Uhm et al |

### FIELD OF THE INVENTION

The present invention relates to an apparatus and method for generating pure steam torch by microwaves and more particularly to the microwave steam torch for generation of high-temperature steam plasma by injecting steam into discharge tube energized by microwaves. The present invention is also useful for reforming of hydrocarbon fuels by injecting gaseous, liquid or solid-powder hydrocarbon-fuels into the microwave steam torch to decompose the hydrogen and carbon containing fuels, and to mix the resultant gaseous carbon compounds with oxygen or hydroxide molecules, instantaneously generating hydrogen or other hydrocarbon compounds.

### BACKGROUND OF THE INVENTION

Water extinguishes fire very effectively. On the other hand, a water fire, if attainable, can be a heat source for environmental cleanup and may be applicable to renewable energy production. For example, efficient hydrogen production is very important for such necessities as a clean energy source for use in fuel cells, which are viewed as a promising power source for vehicles in the future. However, the hydrogen is very impractical in terms of storage and handling. Moreover, at present and for the foreseeable future, it comes from fossil fuels by reforming natural gas or liquid fuels, which requires high-temperature and high-pressure steam at a plant scale. Most current high-pressure reforming devices are likely to be inadequate for use as portable systems. In this context, a high-temperature steam torch in place of a high-pressure reforming device may be useful for hydrogen production from hydrocarbon fuels. A steam plasma torch contains highly active species, enhancing the chemical reaction rate and eliminating the need for catalysts in material processing.

The plasma torch in general is a device of arc plasma column generated between two electrodes. There are several kind of plasma torch including DC arc torch, induction torch and high-frequency capacitive torch. The DC arc torch is operated by the DC electric field between two electrodes, which must be replaced often due to their limited lifetime. The DC arc torch is also operated at a high arc current in the range of 50-10,000 A, which requires an expensive high electrical-power supplier. The induction torch and high-frequency capacitive torch are inefficient devices with typical thermal efficiency in the range of 40-50%. These conventional torches have a small volume of plasma, have high operational cost and require many expensive additional systems for operation.

In order to overcome difficulties of the conventional torches, a microwave plasma torch was proposed in U.S. Pat. No. 6,620,394 B2 issued to Uhm et. al., present inventors, on Sep. 16, 2003. The previous microwave plasma torch provides high density and high temperature plasmas in inexpensive ways, but pure steam has not been used as the working gas. In this context, the purpose of the present invention is providing an apparatus and method for generating a pure steam torch by injecting steam into discharge tube energized by microwaves.

### SUMMARY OF THE INVENTION

In order to generate a pure steam-plasma torch, the present invention includes a magnetron that generates microwaves;

a power supply system that provides an electrical power to the magnetron;

a microwave circulator that forwards the microwaves from the magnetron to a discharge tube and absorbs the reflected microwaves;

a directional monitoring system that monitors forward and backward microwave powers;

stub tuners that control the forward and backward microwave power;

a tapered waveguide system that delivers effectively the microwave power to the discharge tube;

a discharge tube wherein an oncoming microwave power is converted into a plasma column in a swirl gas injected from outside;

a steam supplier that provides the swirl steam to the discharge tube;

an ignitor that provides initial electrons to ignite plasma inside the discharge tube; and

a fuel supply system that injects hydrocarbon fuels into the steam plasma in the discharge tube and reforms the fuels through the steam plasma.

The purpose of this invention is to modify the microwave plasma torch design such that the improved apparatus produces a stable steam-plasma torch suited for such environmental and energy applications as burning toxic materials and producing hydrogen gas through fuel reforming. The key feature of this invention is directed to adding a steam supply system to the discharge tube whereby producing a stable steam-plasma torch at one atmospheric pressure.

It is therefore an important object of the present invention to generate a stable steam-plasma torch with high temperature and swirl steam gas so that this plasma torch flame serves as a high temperature steam for reforming natural gas or liquid fuels and producing hydrogen.

Other object of the present invention is generation of a stable steam-plasma torch with high temperature so that this plasma flame serves as a high temperature source in waste incineration facilities where hazardous materials like dioxins may not be formed because of controlled incineration temperature due to the high temperature source of the present invention.

Another object of the present invention is generation of a stable steam-plasma torch with high temperature for elimination of volatile organic compounds (VOCs) in air, elimination of dioxins from incinerators, elimination of hydrogen sulfide from factories and elimination of ammonia compounds from waste of livestock farms.

Additional objects, and advantages and novel features of the invention will be explained in the description which follows, and in part will be apparent from the description, and will be learned by practice of the invention. The objectives and other advantages of the invention will be realized and obtained by the process and apparatus, particularly pointed out in the written description and claims hereof, as well as the appended drawings.

### BRIEF DESCRIPTION OF DRAWING FIGURES

A more complete appreciation of the invention and many of its attendant advantages will be aided by reference to the following detailed description in connection with the accompanying drawings:

FIG. 1 is a block diagram illustrating the apparatus related to the pure steam torch energized by microwaves of the present invention;

FIG. 2 is a side cross-sectional view of a pure steam torch energized by microwaves in one of desirable examples of the present invention;

FIG. 3 is the measured data of the flame temperature T versus the axial distance z from the center for the plasma torch flame at 2 kW;

FIG. 4 is plots of the normalized light intensity I_{OH}=(x/x₀)(T/T₀)³ of the OH radicals at 309 nm versus the gas temperature in Kelvin. The light is normalized by that at the temperature T=6500 K. The solid line is the theoretical prediction obtained from I_{OH}=(x/x₀)(T/T₀)³ with Eq. (2) at T₀=6500 K, and dots represent the measured data.

### DETAILED DESCRIPTION

The present invention is about an apparatus for generating pure steam torch by microwaves and particularly to the microwave steam torch for generation of high-temperature steam plasma by injecting steam into discharge tube energized by microwaves. The present invention is also useful for reforming of hydrocarbon fuels by injecting gaseous, liquid or solid-powder hydrocarbon-fuels into the microwave steam torch, providing a portable reforming device for hydrogen production from hydrocarbon fuels.

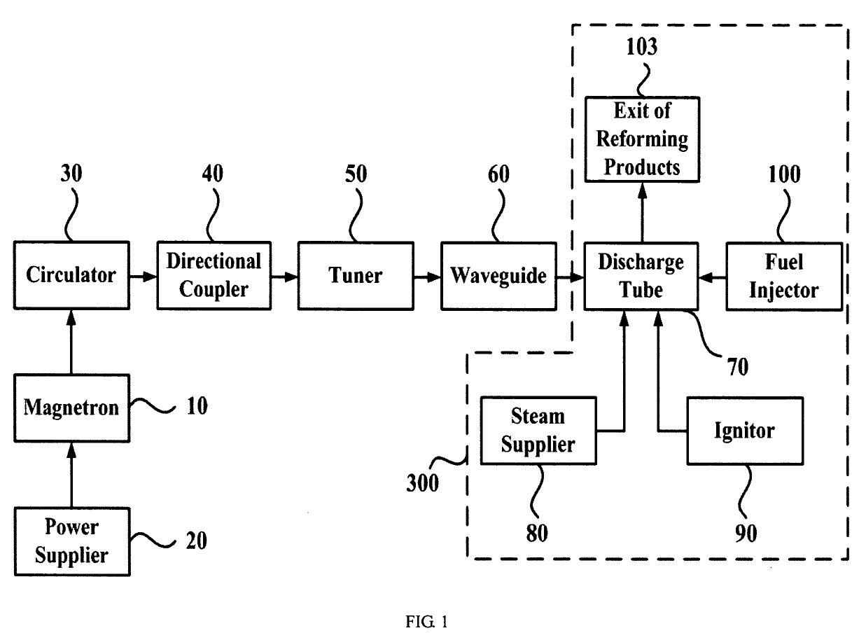

Referring now to the drawing in details, FIG. 1 is diagram of the steam-plasma torch system. The basic portion of the present invention is the discharge tube 70 and other adjacent devices 300, where pure steam enters the discharge tube 70 made of dielectric materials like quartz or alumina through the steam supplier 80, making a swirl gas inside the discharge tube 70. The power supplier 20 made of AC transformers or DC power suppliers provides the electrical power into the magnetron 10, which generates microwaves. The circulator 30 sends the microwaves from the magnetron 10 into the directional coupler 40 and protects the magnetron 10 from reflected waves caused by impedance mismatching, which can be corrected by the 3-stub tuner 50, reducing the reflected wave intensity less than 1%. The reflected wave intensity is less than 10% of the incoming wave intensity even without tuner adjustment, once the plasma torch is ignited.

The electrode tips of the ignitor 90 inside the discharge tube 70 provide initiation electrons of the plasma column in the discharge tube 70. The swirl steam gas from the steam supplier 80 inside the discharge tube 70 stabilizes steam-plasma column and protects inner wall of the discharge tube 70 from steam-plasma heat. The steam-plasma column length depends on the amount of swirl gas. For example, the steam-plasma column length is about 30-40 cm for 1 kW microwave power with 2.45 GHz, for a quartz discharge tube with 27 mm inner diameter and for 20 liters per minute (lpm) of steam swirl. The hydrocarbon fuel from the fuel injector system 100 enters the discharge tube 70 sideways and the fuel reforming gas generated from fuel with steam-plasma exits through the exit 103 of reforming products. For example, the liquid hydrocarbon fuel evaporates instantaneously by the steam-plasma column with its center temperature of 5500-6500 degree Celsius and reforms immediately with steam. The aforementioned hydrocarbon fuel is methane, ethane, propane, butane in gaseous state, gasoline, diesel, kerosene, bunker oil, waste oil in liquid state and coal powders in solid state, etc.

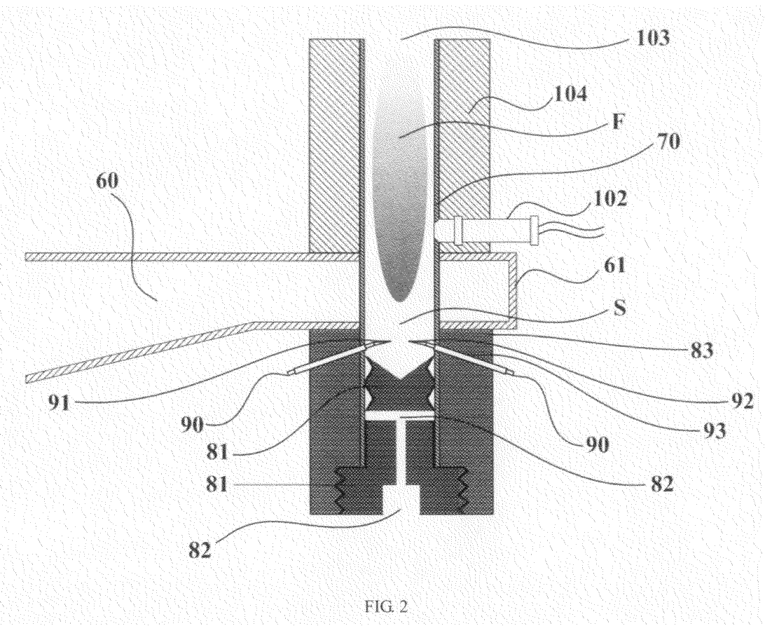

FIG. 2 is a side cross-sectional view of the apparatus designated by the dashed box 300 in FIG. 1 and represents a drawing of the steam-plasma torch and fuel injector. The microwaves from the 3-stub tuner 50 in FIG. 1 passes through the tapered waveguide 60 and enter the discharge tube 70 installed at the location a quarter wavelengths away from the end 61 of the waveguide 60. Height of the tapered waveguide 60 attached to a standard rectangular waveguide (86 mm width and 43 mm height) is gradually reduced to induce the maximum energy density at the discharge tube 70 location. The steam supplier 80 consists of the first block 81, the steam swirl injectors 82 and the second block 83 in FIG. 2. The first block 81 provides the space S inside the discharge tube 70. The swirl injectors 82 looks like intersect the first block 81 in FIG. 2, but they are holes in three dimension and do not intersects the first block 81 in reality. The second block 83 is connected to the first block 81 and wraps around the aforementioned discharge tube 70. These blocks are made of metal or conducting materials. The upper surface of the first block 81 is exposed to an extremely high temperature and must endure in a high temperature environment. The steam swirl injectors 82 has more than one spiral pathway along the gap between the discharge tube 70 and the first block 81. The steam swirl gas passing through this steam swirl injector 82 enters the discharge tube 70 creating a swirl inside the discharge tube 70, stabilizing the plasma column and protecting the discharge tube 70 from the heat of the steam torch. The ignitor 90 provides initiation electrons of the plasma column from the microwaves and the swirl steam gas, and its electrode tip must be located inside the discharge tube 70. The ignitor 90 consists of the tungsten electrode 91 (or 92) wrapped by a dielectric material 93 such as ceramic, in order to prevent arcing between the ignitor 90 and the second block 83.

The aforementioned fuel injector 100 supplies the hydrocarbon fuels into the steam plasma flame F, reforming the fuels. The reforming gases exits through the exit 103 of the reforming products. The fuel injector 100 consists of the nozzle 102, the exit 103 of the reforming products and the cylindrical structure 104. The aforementioned nozzle 102 attached to the discharge tube 70 injects the hydrocarbon fuels into the discharge tube 70. There can be one or more than one nozzles installed. The hydrocarbon fuels injected by the nozzles are methane, ethane, propane, butane in gaseous state, gasoline, diesel, kerosene, bunker oil, waste oil in liquid state and coal powders in solid state, etc. In order to protect the discharge tube 70, the cylindrical structure 104 wraps around the discharge tube 70.

The operational process of the aforementioned steam-plasma torch by microwaves and reforming of the fuels is as follow: The electric power from the power supplier 20 energizes magnetron 10, generating microwaves, which are delivered to the discharge tube 70 through circulator 30, directional coupler 40, the stub tuners 50 and the waveguide 60. Steam from a steam generator passes through the steam supplier 80, which delivers the steam into the space S in the discharge tube 70 as swirl gas. The first block 81 heated by the discharge heat in the discharge tube 70 also heat the steam passing through it.

If the microwaves are injected inside the discharge tube 70, the electrons supplied from the electrodes of the ignitor 90 initiates plasma in the steam swirl gas, producing the steam-plasma torch. The steam swirl gas stabilizes the plasma column inside the discharge tube 70 and protects the inner wall of the discharge tube 70 from the discharge heat, forming the steam-plasma torch. 2 kW microwave with 2.45 GHz provides plasma flame with 5500-6500° C., where the water molecules disintegrate. This high temperature plasma torch can also be a high temperature heat source for incineration of municipal wastes or elimination of various hazardous materials.

### EXAMPLE

As an example, a steam-plasma torch experiment was conducted with microwaves of 2.45 GHz frequency. A commercially available steam generator originally used for carpet cleaning produces 25 grams of steam in a minute at five times the atmospheric pressure in experiments. The steam temperature at the exit of the steam generator is 160° C.; however, it cools rapidly and requires additional heating before it enters a discharge tube 70 made of quartz. The steam enters the discharge tube 70 as a swirl gas. The necessary temperature of the steam for ignition of the plasma in the discharge tube 70 must be 150° C. or higher.

The quartz discharge tube 70 sits on the first block 81 made of carbon (graphite) or steel block, which is located inside the heating device. The steam swirl gas passes through the block 81, which is cold before the plasma ignition but is quickly heated during the discharge. The additional heating of the steam before ignition is a critical factor for the initiation of the discharge. The block surface inside the discharge tube 70 has a hemi-spherical concave shape and must endure an extremely high temperature.

Typical examples of steam plasma torches are initiated inside a quartz tube, 3 cm in diameter and 50 cm in length. The torch flame becomes longer as the electrical power increases, as expected. The steam plasma torch is very stable and can usually operate for more than two hours until all of the water in the tank of the steam generator is consumed. A steam torch is ignited in a quartz tube with a length of 50 cm, and the diameter and length of the flame are measured in terms of the supplied electrical power. It is noted from the measurement of the flame size that the flame volume increases almost linearly with the electrical power.

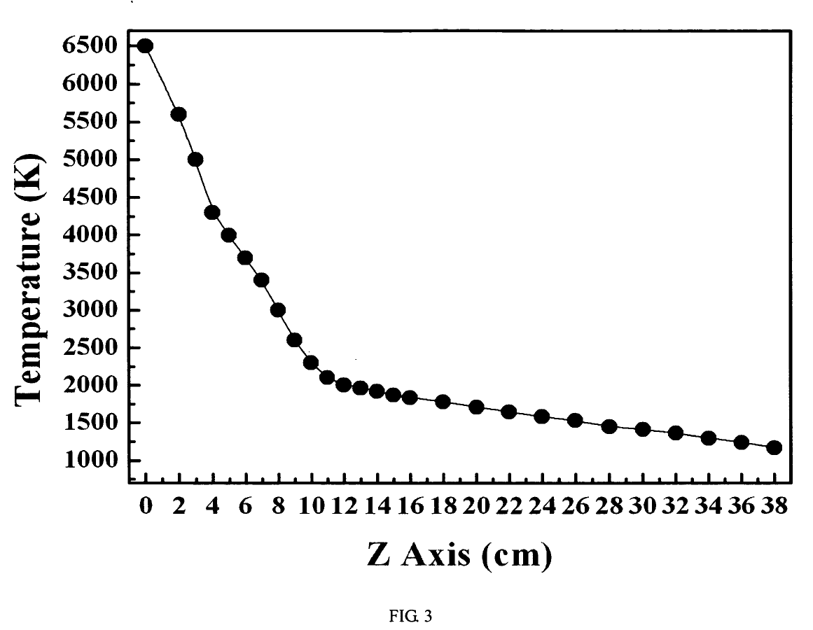

The high gas temperature was estimated by making use of the optical spectrum, in which the experimental data of the optical signals were obtained through an optical fiber placed near a specified portion of z in the plasma torch. Here, z represents the distance from the center of torch, where the base of the torch is located inside the waveguide, designating z=0 as the center of the flame. Shown in FIG. 3 is the measured data of the flame temperature T versus the axial distance z from the center for the 2 kW plasma flame. It is clear from FIG. 3 that there are two distinctive regions of the steam torch flame; a high-temperature zone and a relatively low-temperature zone. The torch flame of the high-temperature zone ranging from z=0 to z=10 cm is white and bright, as it is the typical emission of a high-temperature plasma. Additionally, the flame color of parts of the low-temperature zone beyond z=10 cm becomes reddish, characterizing hydrogen burning in oxygen.

The water molecules at high temperatures dissociate into OH radicals and hydrogen atoms according to H₂O→OH+H with a bimolecular reaction constant of α_{N}=2.66×10⁻⁷ exp(−57491/T) cm³/molecules/s, which is several orders higher than other dissociative reaction constants of water at high temperatures. The dominant recombination reaction of water molecules is given by 2OH→H₂O+O with a reaction constant of α_{OH}=1.02×10⁻¹²(T/Tᵣ)^{1.4} exp(200/T) cm³/molecules/s. Here, Tᵣ=298K is the room temperature. The rate equation of the water molecules with density n_{H2O} is therefore expressed as

$$\frac{d {n}_{H 2 O}}{d t} = {α}_{OH} {n}_{OH}^{2} - {α}_{N} {n}_{N} {n}_{H 2 O} , \qquad ( 1 )$$

where n_{OH} and n_{N} represent hydroxide and neutral densities, respectively. The neutral density n_{N}=2.7×10¹⁹(Tᵣ/T) particles/cm³ in Eq. (1) at one atmospheric pressure is inversely proportional to the gas temperature T according to the equation of state for the ideal gas.

After carrying out a straightforward analytical calculation, the normalized hydroxide density x=n_{OH}/n_{N} at the thermal equilibrium characterized by dn_{H2O}/dt=0 in Eq. (1) is obtained as

$$x = \sqrt{\frac{{α}_{N}^{2}}{4 {α}_{OH}^{2}} {( a γ + \frac{b}{γ} + 1 )}^{2} + \frac{{α}_{N}}{{α}_{OH}}} - \frac{{α}_{N}}{2 {α}_{OH}} ( a γ + \frac{b}{γ} + 1 ) , \qquad ( 2 )$$

where the ratio γ=n_{H}/n_{O} of hydrogen atom to oxygen atom densities is expressed as

$$γ = \frac{1}{4 a} + \sqrt{\frac{1}{16 {a}^{2}} + \frac{2 b}{a}} , \qquad ( 3 )$$

and the constants a and b are defined as a=0.44 exp(1030/T) and b=3.9×10⁻²(T/Tᵣ)^{0.4} exp(8311/T) in terms of gas temperature Tin Kelvin.

The normalized hydroxide (n_{OH}/n_{N}=x) and water (n_{H2O}/n_{N}) molecular densities are obtained from Eq. (2) with n_{H2O}/n_{N}=1−[aγ+(b/γ)+1]x. A substantial fraction of water molecules disintegrates into other compounds at a high temperature. For example, the normalized water-molecular density is calculated to be n_{H2O}/n_{N}=1−[aγ+(b/γ)+1]x=0.5 at T=5300K according to Eq. (2). Assuming that the gaseous water molecules disintegrate into hydrogen and oxygen molecules according to 2H₂O→2H₂+O₂, enthalpy and entropy changes due to this reaction are found from a table to be ΔH=483.6 kJ/mole and ΔS=88.8 J/mole/deg, respectively. The Gibbs free energy of the disintegration is given by G=ΔH−TΔS; therefore, the disintegration temperature of the water molecules is calculated to be T=ΔH/ΔS=5400K, which is close to T=5300K for n_{H2O}/n_{N}=0.5. It is also noted from Eq. (2) that the normalized hydroxide molecular density increases considerably, as it is a substantial fraction of unity, as the gas temperature T increases to 6500K.

The density n_{OH} of the hydroxide molecules for a specified value of x in Eq. (2) is proportional to the neutral density n_{N}, which is inversely proportional to the gas temperature T according to the equation of state for the ideal gas. Therefore, the hydroxide density is expressed as n_{OH}=n_{N0}(x/x₀)(T₀/T), where x₀ and n_{N0} are the normalized OH and neutral densities, respectively, at a specified temperature T₀. The light intensity emitted at a wavelength of 309 nm of the hydroxide molecules is proportional to the mean energy density u_{OH} of the photon, which is proportional to T⁴. The mean energy density u_{OH} of the photon at the wavelength of 309 nm may also be proportional to the hydroxide density n_{OH}. Thus, the normalized light intensity I_{OH} can be expressed as I_{OH}=(x/x₀)(T/T₀)³, which is normalized by the light intensity at the temperature T₀.

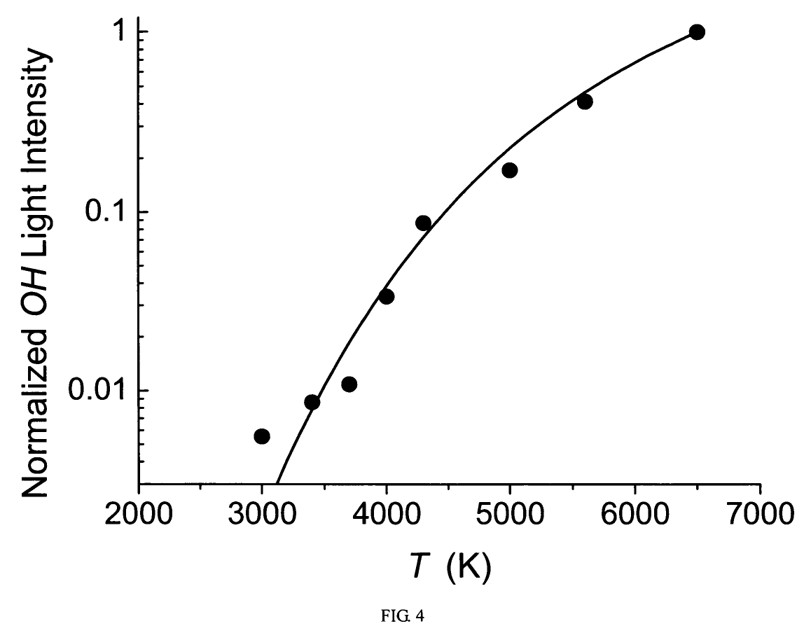

The light emission intensity can be measured relatively in terms of the light emission at T=T₀. The normalized light intensity I_{OH} at 309 nm is plotted in FIG. 4 versus the gas temperature T in Kelvin. The light intensity is normalized by that at the temperature T₀=6500K. The solid curve represents the theoretical predictions with Eq. (2) and the dots are experimental data at 309 nm of the OH emission. The experimental data were measured at z=0, 2, 3, 4, 5, 6, 7, and 8 cm, which correspond to T=6500, 5600, 5000, 4300, 4000, 3700, 3400, and 3000K, respectively, according to FIG. 3. The OH emission intensity decreases drastically as the gas temperature T decreases from T=6500K. The emission profiles of the experimental data at a high temperature agree reasonably well with the theoretical predictions. The emission intensity measurement of OH radical light in a relatively low-temperature range is very difficult because of noise caused by flame fluctuations. Note from FIG. 4 that the normalized light intensity at temperatures below T=3000K is less than 0.5 percents, being vulnerable to flame noise.

A high-temperature steam torch may have a potential application of the hydrocarbon fuel reforming at one atmospheric pressure. As an example, we consider reforming of the methane gas according to 2H₂O+CH₄>CO₂+4H₂. The enthalpy and entropy changes due to this reaction can be calculated to be ΔH=165 kJ/mole and ΔS=172.4 J/mole/deg, respectively. The Gibbs free energy of the reaction is given by G=ΔH−TΔS and therefore the reaction temperature of the reforming is calculated to be T=ΔH/ΔS=957K. The temperature of the steam plasma torch shown in FIG. 3 is much higher than the reaction temperature T=957K in most of the torch flame at the atmospheric pressure. Moreover, the radicals including hydrogen, oxygen and hydroxide molecules are abundantly available in the steam torch, dramatically enhancing the reaction speed. The methane may also break down at high temperatures. On the other hand, methane reforming in a conventional steam system may need a high pressure device to sustain the reaction temperature and to hold the chemicals for a long residence-time required for the reforming reactions.

Although this embodiment is the apparatus and method for generating pure steam torch by microwaves and for reforming of hydrocarbon fuels by injecting gaseous, liquid or solid-powder hydrocarbon-fuels into the microwave steam torch to decompose the hydrogen and carbon containing fuels, and to mix the resultant gaseous carbon compounds with oxygen or hydroxide molecules, instantaneously generating hydrogen or other hydrocarbon compounds, the invention is not limited to the use of the steam-plasma torch. Without departing from the spirit of the invention, numerous other rearrangements, modifications and variations of the present invention are possible in light of the foregoing teachings. It is therefore to be understood that within the scope of the appended claims, the invention may be practiced otherwise than as specifically described.

What is claimed is:

1. An apparatus of generating a pure steam torch by microwaves for reforming of hydrocarbon fuels, said apparatus comprising:
(a) a discharge tube equipped with a microwave radiation generator for forming a pure steam-plasma torch with an ignition device, a steam supplier for swirl gas and a tapered waveguide; and
(b) a fuel injector system that injects hydrocarbon fuels into the steam-plasma in said discharge tube for reforming said hydrocarbon fuels by high-temperature steam-plasma.

2. In the apparatus according to claim 1, wherein said steam supplier provides at least one swirl-gas passage between the internal space of said discharge tube and the outside of the upstream block with its internal hole in continuation to the internal space of said discharge tube.

3. In the apparatus according to claim 2, wherein said upstream block under said discharge tube is made of such metals as stainless steel or is made of compressed carbon for isolation from microwave influence.

4. In the apparatus according to claim 2, wherein said swirl-gas passage is inclined toward downstream, being a spiral pathway.

5. In the apparatus according to claim 1, wherein said fuel injector system with at least one fuel nozzle is attached to a cylindrical structure installed on top of said discharge tube and equipped with exit of reforming gas.

6. A process for generating a steam-plasma torch by microwaves and reforming of hydrocarbon fuels by
(a) focusing microwaves at the center of a discharge tube and initiating a steam-plasma torch inside said discharge tube; and
(b) injecting gaseous, liquid or solid-powder hydrocarbon-fuels into the steam-plasma torch through fuel injectors and reforming said hydrocarbon fuels by said steam-plasma torch

7. In the process according to claim 6, wherein said steam-plasma torch is generated in the steam swirl-gas injected through a steam supplier into said discharge tube.

8. In the process according to claim 6, wherein said hydrocarbon fuel is methane, ethane, propane, butane in gaseous state, gasoline, diesel, kerosene, bunker oil, waste oil in liquid state, coal powders, carbon powders in solid state, or a mixture of these fuels.

9. In the process according to claim 6, wherein temperature of said steam swirl-gas is higher than 150 degree Celsius in said discharge tube before the plasma ignition.

10. In the process according to claim 6, wherein the microwave frequency from a microwave radiation generator is in the range of 500 MHz-10 GHz.
